(19) United States
(12) Patent Application Publication
(10) Pub. No.: US 2013/0138409 A1
(43) Pub. Date: May 30, 2013

(54) METHOD OF CALCULATING MUD WEIGHT IN BOREHOLE FORMED IN ANISOTROPIC ROCK FORMATION

(71) Applicant: Korea Institute Of Geoscience and Mineral Resour, Daejeon (KR)

(72) Inventors: Hi-Kweon LEE, Daejeon (KR); Tae-Hee KIM, Daejeon (KR); Byung-Woo YUM, Daejeon (KR)

(73) Assignee: Korea Institute Of Geoscience and Mineral Resources, Daejeon (KR)

(21) Appl. No.: 13/683,725

(22) Filed: Nov. 21, 2012

(30) Foreign Application Priority Data
Nov. 25, 2011 (KR) 10-2011-0124012

(51) Int. Cl. G06F 17/13

(52) U.S. Cl. CPC G06F 17/13
USPC 703/2

(57) ABSTRACT

Provided are embodiments of a section marking apparatus and method for dividing a geological survey site into one or more sections. In some embodiments, the section marking apparatus includes a case part, a fixing shaft part, a section marking part, and a driving pin part. The fixing shaft part is accommodated in the case part. The section marking part is coupled to the fixing shaft part, received in the case part, and has a marker string configured to be extracted to the outside of the case part. The driving pin part is coupled to the fixing shaft part and configured to be driven into a ground surface to secure the section marking apparatus to the ground surface. Accordingly, the section marking apparatus can be used to divide a site when the ground is flat or when the ground is uneven and/or has a slope.

### CROSS-REFERENCE TO RELATED APPLICATION

This application claims priority to Korean Patent Application No. 10-2011-0124012 filed on Nov. 25, 2012, and all the benefits accruing therefrom under 35 U.S.C. §119, the contents of which are incorporated by reference in their entirety.

### BACKGROUND

When a borehole is bored into the lithosphere under an in-situ stress field, stress concentration is caused around the borehole. The stress concentration is influenced by a direction of the borehole, a scale and direction of the in-situ stress, pressure of mud, physical properties of rock, and so on. If the concentrated stress exceeds the strength of the rock, the rock is destroyed, and thus the borehole will be damaged. To prevent this damage to the borehole, a method of applying the pressure of mud to the interior of the borehole so as to support a wall of the borehole is used.

Generally, the mud pressure required has been decided by a traditional analysis of borehole wall stability which assumes that a rock formation has anisotropic strength. Since the traditional analysis ignores strength anisotropy of a weak plane such as a bedding plane, a foliated structure, or a schistosity plane, incorrect results may be obtained when safe mud weight for the borehole formed in a thin stacked rock formation, particularly, such as mudstone or phyllite, is decided. Thus, a new method capable of analyzing stability of the borehole formed in the rock formation having anisotropic strength is required.

### SUMMARY

The present disclosure provides provide a method of calculating a weight of mud by which stability of a borehole formed in a rock formation having anisotropic strength can be secured. The method includes the steps of: calculating maximum mud weights required to prevent breakages occurring along the weak planes at a plurality of respective points located at a predetermined depth in a wall of the borehole having a predetermined azimuth angle and a predetermined dip angle based on information about the rock matrix, the weak plane, and the rock formation, and maximum mud weights required to prevent breakages of the rock matrixes at the plurality of respective points; and comparing a greatest value of the maximum mud weights required to prevent breakages occurring along the weak planes with a greatest value of the maximum mud weights required to prevent breakages of the rock matrixes at the plurality of respective points, and setting a greater one of the greatest values to a critical mud weight at the predetermined depth of the borehole.

Here, the information about the rock matrix may include a cohesive force of the rock matrix and a coefficient of friction of the rock matrix, and the information about the weak plane may include a cohesive force of the weak plane, a coefficient of friction of the weak plane, a dip angle of the weak plane, and a dip direction of the weak plane. Further, the information about the rock formation may include information about a state of in-situ stress defined by vertical stress, maximum horizontal stress, minimum horizontal stress, and an azimuth angle of the minimum horizontal stress, a Poisson's ratio of the rock formation, a Biot's parameter of the rock formation, and information about a pore water pressure in the rock formation.

Further, the step of calculating maximum mud weights required to prevent breakages occurring along the weak planes may include: a first step of calculating in-situ stress distribution on the rock formation in a borehole coordinate system corresponding to the azimuth and dip angles of the borehole based on the information about the rock formation; a second step of setting a predetermined mud weight supporting the wall of the borehole and calculating stress components applied to the wall at a point located at the depth of the wall of the borehole based on the mud weight and the in-situ stress distribution; a third step of calculating the maximum mud weight required to prevent the breakage occurring along the weak plane at the point while changing the mud weight; and a fourth step of sequentially repeating the second and third steps with respect to different points located at the depth of the wall of the borehole to calculate the maximum mud weights required to prevent the breakages occurring along the weak planes at the respective different points.

Also, the second step may include setting the predetermined mud weight, and calculating stress components of the point in a cylindrical coordinate system based on both the in-situ stress distribution in the borehole coordinate system and the set mud weight.

In addition, the third step may include: projecting the stress components of the point in the cylindrical coordinate system on the weak plane, converting the stress components in the cylindrical coordinate system into stress components in a weak plane coordinate system, and calculating the stress components in the weak plane coordinate system; determining whether or not the breakage caused by the weak plane occurs based on the stress components in the weak plane coordinate system and the information about the weak plane; and when it is determined that the breakage caused by the weak plane occurs, increasing the set mud weight by a predetermined value to calculate the stress components in the weak plane coordinate system again based on the increased mud weight, and determining again whether or not the breakage caused by the weak plane occurs based on the re-calculated stress components in the weak plane coordinate system and the information about the weak plane.

### BRIEF DESCRIPTION OF THE DRAWINGS

Exemplary embodiments can be understood in more detail from the following description taken in conjunction with the accompanying drawings, in which:

FIG. 1 is an algorithm for describing a method of calculating a weight of mud in a borehole in accordance with an embodiment of the present disclosure;

FIG. 2 is a view for illustrating the relation between GCS and BCS;

FIG. 3 is a view for illustrating the relation between ICS and GCS;

FIG. 4 is a view for illustrating the relation between BCS and CCS;

FIG. 5 is a view for illustrating the relation between GCS and WCS; and

FIG. 6 is a view for illustrating vertical stress σ^{w}ₓₓ and two shear stresses τ^{w}_{xy} and τ^{w}_{xz}, all of which are projected on the weak plane.

### DETAILED DESCRIPTION OF EMBODIMENTS

Exemplary embodiments will be described in detail with reference to the accompanying drawings. Since the present disclosure may have modified embodiments, preferred embodiments are illustrated in the drawings and are described in the detailed description of the invention. However, this does not limit the present disclosure within specific embodiments and it should be understood that the present disclosure covers all the modifications, equivalents, and replacements within the idea and technical scope of the present disclosure. In the drawings, the dimensions and size of each structure may be exaggerated, omitted, or schematically illustrated for convenience in description and clarity.

It will be understood that although the terms of first and second are used herein to describe various elements, these elements should not be limited by these terms. Terms are only used to distinguish one component from other components. Therefore, a component referred to as a first component in one embodiment can be referred to as a second component in another embodiment.

In the following description, the technical terms are used only for explaining a specific exemplary embodiment while not limiting the present disclosure. The terms of a singular form may include plural forms unless referred to the contrary. The meaning of ‘include’, ‘have’, or ‘comprise’ specifies a property, a step, a function, an element, or a combination thereof, but does not exclude other properties, steps, functions, elements, or combinations thereof.

Unless terms used in the present description are defined differently, the terms should be construed as having the one or more meanings known to those skilled in the art. Terms that are generally used and have been defined in dictionaries should be construed as having meanings matched with contextual meanings in the art. In this description, unless defined clearly, terms are not ideally or excessively construed as formal meanings.

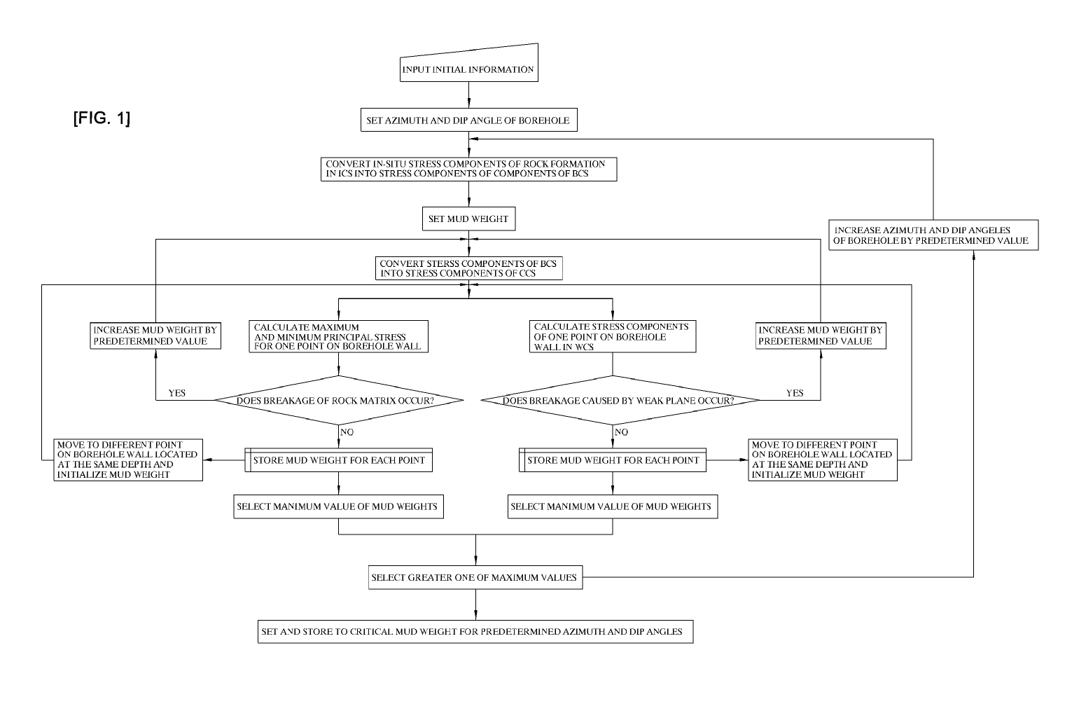

FIG. 1 is an algorithm for illustrating method of calculating a weight of mud in a borehole in accordance with an embodiment of the present disclosure.

Referring to FIG. 1, to calculate the mud weight in accordance with the embodiment of the present disclosure, first, initial information is collected and stored. The initial information includes information about a rock formation at a predetermined depth, information about a rock matrix, and information about a weak plane. The information about the rock formation includes information about a state of in-situ stress in the rock formation before the borehole is formed, a Poisson's ratio ν of the rock formation, a Biot's parameter α of the rock formation, and information about a pore water pressure Pₚ in the rock formation. The information about the in-situ stress state of the rock formation includes information about vertical stress σᵥ, maximum horizontal stress σ_{H}, minimum horizontal stress σₕ, and an azimuth angle of the minimum horizontal stress σₕ. The information about the rock matrix includes a cohesive force Sᵢ of the rock matrix and a coefficient of friction μᵢ of the rock matrix. The information about the weak plane includes information about a cohesive force S_{w} of the weak plane, a coefficient of friction μ_{w} of the weak plane, a dip angle of the weak plane, and a dip direction of the weak plane.

Subsequently, an azimuth angle α_{b} and a dip angle (deviation) β_{b} at a predetermined depth of the borehole for which the mud weight is to be calculated are set. The borehole of the predetermined depth may be expressed in a borehole coordinate system (BCS), and the azimuth angle α_{b} and the dip angle β_{b} of the borehole may be set on the basis of a global coordinate system (GCS).

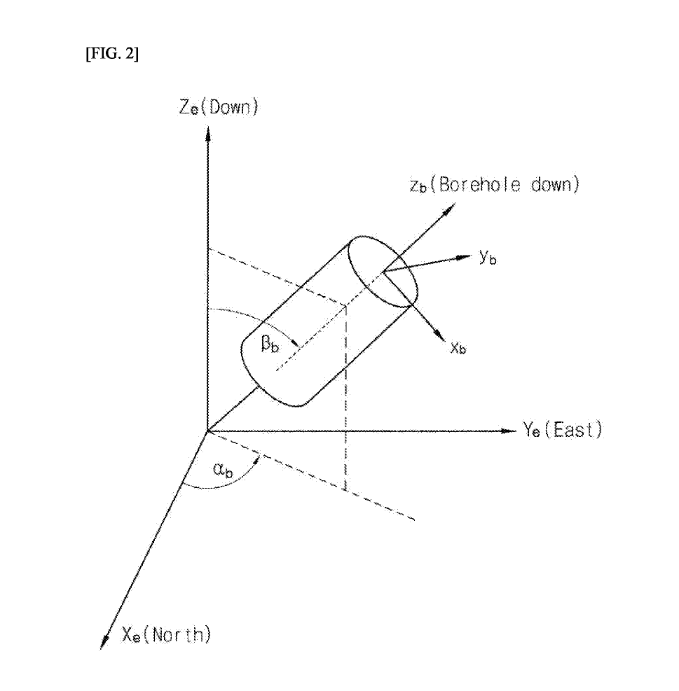

FIG. 2 is a view for illustrating the relation between the GCS and the BCS.

Referring to FIG. 2, the GCS is defined by an Xₑ axis arranged northward, a Yₑ axis arranged eastward, and a Zₑ axis arranged vertically downward. The BCS is defined by a z_{b} axis arranged downward from the central axis of the borehole, an x_{b} axis directed from the center of a cross section of the borehole perpendicular to the z_{b} axis toward one point located at an edge of the borehole cross section, and a y_{b} axis formed on the borehole cross section at an angle of 90° counterclockwise from the x_{b} axis. The x_{b} axis is set so that a projection line obtained by projecting the x_{b} axis on an XₑYₑ plane is identical to a projection line obtained by projecting the z_{b} axis on the XₑYₑ plane. The azimuth angle α_{b} of the borehole is defined by an angle from the Xₑ axis to the projection line of the z_{b} axis projected on the XₑYₑ plane. The dip angle β_{b} of the borehole is defined by an angle from the Zₑ axis to the z_{b} axis. To design the borehole, there is a need to calculate the mud weights with respect to all the azimuth angles and dip angles, because an optimum direction of the borehole can be set on the basis of the calculated mud weights. To this end, initial setting values of the azimuth angle α_{b} and the dip angle β_{b} of the borehole may be 0° and 0°, respectively.

Next, BCS values of in-situ stress components in the rock formation are calculated. When the in-situ stress components stored first are expressed as values of an in-situ stress coordinate system (ICS), the values are converted into GCS values, and then the GCS values are reconverted into BCS values. The in-situ stress components in the ICS can be expressed as in Equation 1 below.

$${σ}_{ics} = [ \begin{matrix}{σ}_{h} & 0 & 0 \\ 0 & {σ}_{H} & 0 \\ 0 & 0 & {σ}_{v}\end{matrix} ] \qquad [ Equation 1 ]$$

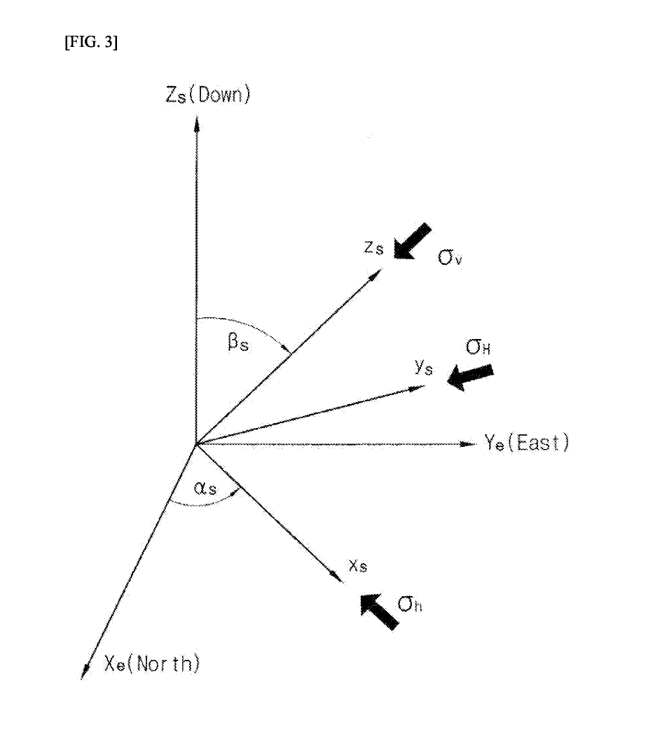

FIG. 3 is a view for illustrating the relation between the ICS and the BCS.

Referring to FIG. 3, the ICS is defined by an x, axis arranged in the direction of minimum horizontal principal stress σₕ, a yₛ axis arranged in the direction of maximum horizontal principal stress σ_{H}, and a zₛ axis arranged in the direction of vertical stress σᵥ. The ICS and the GCS are determined by a stress azimuth angle αₛ and a stress dip angle βₛ. The stress azimuth angle αₛ is defined by an angle from the Xₑ axis to the xₛ axis, and the stress dip angle βₛ is defined by an angle from the Zₑ axis to the zₛ axis. A circulant matrix E for converting stress components of the ICS into stress components of the GCS can be expressed by Equation 2 below, and a determinant for converting in-situ stress components expressed by ICS values into stress components of the GCS can be expressed by Equation 3 below.

$$\begin{matrix}\begin{matrix}E = [ \begin{matrix}cos {β}_{s} & 0 & sin {β}_{s} \\ 0 & 1 & 0 \\ - sin {β}_{s} & 0 & cos {β}_{s}\end{matrix} ] \times [ \begin{matrix}cos {α}_{s} & cos {α}_{s} & 0 \\ - sin {α}_{s} & cos {α}_{s} & 0 \\ 0 & 0 & 1\end{matrix} ] \\ = [ \begin{matrix}cos {α}_{s} cos {β}_{s} & sin {α}_{s} cos {β}_{s} & sin {β}_{s} \\ - sin {α}_{s} & cos {α}_{s} & 0 \\ - cos {α}_{s} sin {β}_{s} & - sin {α}_{s} sin {β}_{s} & cos {β}_{s}\end{matrix} ]\end{matrix} & [ Equation 2 ] \\ {σ}_{ics 2 gcs} = {E}^{T} \times {σ}_{ics} \times E = [ \begin{matrix}{σ}_{xx}^{e} & {τ}_{xy}^{e} & {τ}_{xz}^{e} \\ {τ}_{yx}^{e} & {σ}_{yy}^{e} & {τ}_{yz}^{e} \\ {τ}_{zx}^{e} & {τ}_{zy}^{e} & {σ}_{zz}^{e}\end{matrix} ] & [ Equation 3 ]\end{matrix}$$

In Equation 2, E^{T} is the transpose matrix of E.

Referring to FIG. 2, a circulant matrix B for converting the stress components of the GCS converted from those of the ICS into stress components of the BCS can be expressed by Equation 4 below, and a determinant for converting the in-situ stress components expressed by the GCS values into the stress components of the BCS can be expressed by Equation 5 below.

$$\begin{matrix}\begin{matrix}B = [ \begin{matrix}cos {β}_{b} & 0 & sin {β}_{b} \\ 0 & 1 & 0 \\ - sin {β}_{b} & 0 & cos {β}_{b}\end{matrix} ] \times [ \begin{matrix}cos {α}_{b} & sin {α}_{b} & 0 \\ - sin {α}_{b} & cos {α}_{b} & 0 \\ 0 & 0 & 1\end{matrix} ] \\ = [ \begin{matrix}cos {α}_{b} cos {β}_{b} & sin {α}_{b} cos {β}_{b} & sin {β}_{b} \\ - sin {α}_{b} & cos {α}_{b} & 0 \\ - cos {α}_{b} sin {β}_{b} & - sin {α}_{b} sin {β}_{b} & cos {β}_{b}\end{matrix} ]\end{matrix} & [ Equation 4 ] \\ {σ}_{ecs 2 b cs} = B \times {σ}_{ics 2 ecs} \times {B}^{T} = [ \begin{matrix}{σ}_{xx}^{b} & {τ}_{xy}^{b} & {τ}_{xz}^{b} \\ {τ}_{yx}^{b} & {σ}_{yy}^{b} & {τ}_{yz}^{b} \\ {τ}_{zx}^{b} & {τ}_{zy}^{b} & {σ}_{zz}^{b}\end{matrix} ] & [ Equation 5 ]\end{matrix}$$

Subsequently, an arbitrary mud weight for supporting the borehole wall is set. For example, the mud weight may be set to any value selected between 0 and an arbitrary value. To determine the maximum mud weight required to support the borehole wall, the arbitrarily set mud weight may be set to a value within a relatively low range.

Next, in the wall of the borehole having the preset azimuth and dip angles, the maximum mud weights that prevent breakages occurring along the weak planes at respective points of the predetermined depth and the maximum mud weights that prevent breakages of the rock matrixes at the respective points are calculated.

To calculate the maximum mud weights that prevent breakages occurring along the weak planes at the respective points, first, one point on the borehole wall is selected. The stress components at the selected point are calculated in a weak plane coordinate system (WCS). To calculate stress distribution in the WCS at the selected point from the in-situ stress components of the BCS, a relation between the BCS and a cylindrical coordinate system (CCS) and a relation between the WCS and the GCS should be defined.

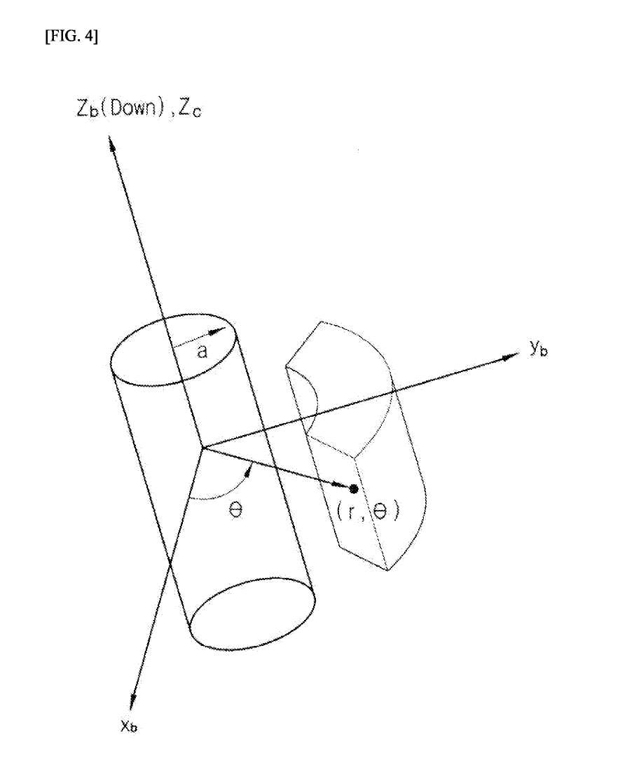

FIG. 4 is a view for illustrating the relation between the BCS and the CCS.

Referring to FIG. 4, the relation between the BCS and the CCS is defined by an angle θ between the x_{b} axis of the BCS and the horizontal axis of the CCS. A circulant matrix C for converting the stress components of the BCS into those of the CCS can be expressed by Equation 6 below.

$$C = [ \begin{matrix}cos θ & sin θ & 0 \\ - sin θ & cos θ & 0 \\ 0 & 0 & 1\end{matrix} ] \qquad [ Equation 6 ]$$

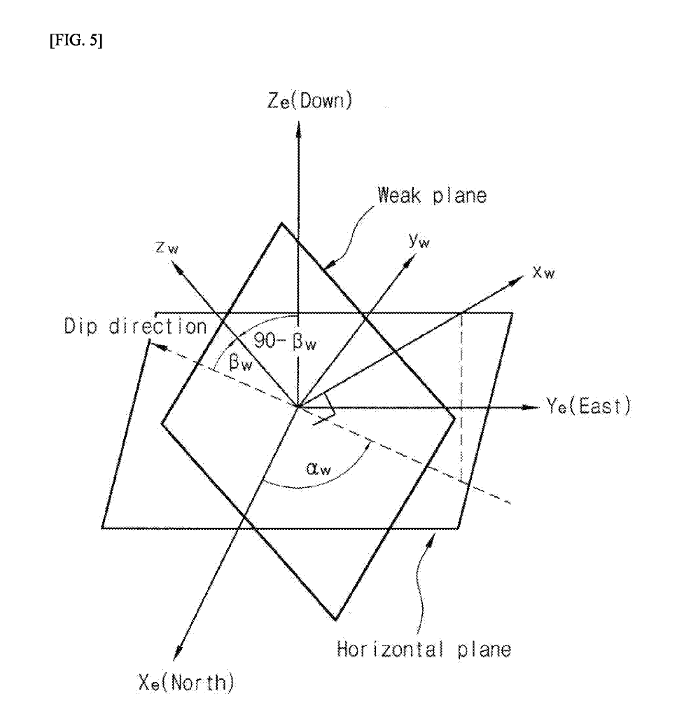

FIG. 5 is an explanatory view showing the relation between the GCS and the WCS.

Referring to FIG. 5, the WCS is defined by an x_{w} axis perpendicular to a weak plane, and z_{w} and y_{w} axes arranged on the weak plane so as to be perpendicular to each other. In the WCS, the z_{w} axis is set so that an angle between a projection line projected on an XₑYₑ plane of the z_{w} axis, i.e. a horizontal plane and a projection line projected on a horizontal plane of the x_{w} axis, is 180°. The relation between the GCS and the WCS is defined by an angle α_{w} measured from the Xₑ axis to the horizontal plane projection line of the x_{w} axis and an angle β_{w} measured from the horizontal plane to the z_{w} axis. The angle α_{w} is equal to “−180° in the dip direction of the weak plane,” and the angle β_{w} indicates the “dip angle of the weak plane.” A circulant matrix W for converting the stress components of the GCS into those of the WCS can be expressed as in Equation 7 below.

$$\begin{matrix}W = [ \begin{matrix}cos ( 90 - {β}_{w} ) & 0 & sin ( 90 - {β}_{w} ) \\ 0 & 1 & 0 \\ - sin ( 90 - {β}_{w} ) & 0 & cos ( 90 - {β}_{w} )\end{matrix} ] \times \\ [ \begin{matrix}cos {α}_{w} & sin {α}_{w} & 0 \\ - sin {α}_{w} & cos {α}_{w} & 0 \\ 0 & 0 & 1\end{matrix} ] \\ = [ \begin{matrix}cos {α}_{w} cos {β}_{w} & sin {α}_{w} sin {β}_{w} & cos {β}_{w} \\ - sin {α}_{w} & cos {α}_{w} & 0 \\ - cos {α}_{w} cos {β}_{w} & sin {α}_{w} cos {β}_{w} & sin {β}_{w}\end{matrix} ]\end{matrix} \qquad [ Equation 7 ]$$

To calculate the stress components distributed at one point on the borehole wall in the WCS, the stress distribution around the borehole can be calculated to CCS values from the in-situ stress components of the BCS using Equations 8 to 13 below, and the calculated stress components of the CCS can be expressed as in Equation 14

$$\begin{matrix}{σ}_{rr}^{′} = \frac{( {a}_{xx}^{b} + {a}_{yy}^{b} )}{2} ( 1 - \frac{{a}^{2}}{{r}^{2}} ) + \frac{( {a}_{xx}^{b} - {a}_{yy}^{b} )}{2} ( 1 - 4 \frac{{a}^{2}}{{r}^{2}} + 3 \frac{{a}^{4}}{{r}^{4}} ) cos 2 θ + {τ}_{xy}^{b} ( 1 - 4 \frac{{a}^{2 }}{{r}^{2 }} + 3 \frac{{a}^{4}}{{r}^{4 }} ) sin 2 θ + {P}_{m} \frac{{a}^{2}}{{r}^{2}} - α {P}_{p} & [ Equation 8 ] \\ {σ}_{θ θ}^{′} = \frac{( {σ}_{xx}^{b} + {σ}_{yy}^{b} )}{2} ( 1 + \frac{{a}^{2}}{{r}^{2}} ) - \frac{( {σ}_{xx}^{b} - {σ}_{yy}^{b} )}{2} ( 1 + 3 \frac{{a}^{4}}{{r}^{4}} ) cos 2 θ - {τ}_{xy}^{b} ( 1 + 3 \frac{{a}^{4}}{{r}^{4}} ) sin 2 θ - {P}_{m} \frac{{a}^{2}}{{r}^{2}} - α {P}_{p} & [ Equation 9 ] \\ {σ}_{zz}^{′} = {σ}_{zz}^{b} - 2 υ ( {σ}_{xx}^{b} - {σ}_{yy}^{b} ) \frac{{a}^{2}}{{r}^{2}} cos 2 θ - 4 {υτ}_{xy}^{b} \frac{{a}^{2}}{{r}^{2}} sin 2 θ - α {P}_{p} & [ Equation 10 ] \\ {τ}_{r θ} = [ \frac{( {a}_{xx}^{b} - {a}_{yy}^{b} )}{2} sin 2 θ + {τ}_{xz}^{b} cos 2 θ ] ( 1 + 2 \frac{{a}^{2}}{{r}^{1}} - 3 \frac{{a}^{4}}{{r}^{4}} ) & [ Equation 11 ] \\ {τ}_{r z} = [ - {τ}_{xz}^{b} sin θ + {τ}_{yz}^{b} cos θ ] ( 1 + \frac{{a}^{2}}{{r}^{2}} ) & [ Equation 12 ] \\ {τ}_{θ z} = [ - {τ}_{xz}^{b} sin θ + {τ}_{yz}^{b} cos θ ] ( 1 + \frac{{a}^{2}}{{r}^{2}} ) & [ Equation 13 ] \\ {σ}_{ccs} = [ \begin{matrix}{σ}_{rr}^{′} & {τ}_{r θ} & {τ}_{rz} \\ {τ}_{r θ} & {σ}_{θθ}^{′} & {τ}_{θ z} \\ {τ}_{rz} & {τ}_{θ z} & {σ}_{zz}^{′}\end{matrix} ] & [ Equation 14 ]\end{matrix}$$

In Equations 8 to 13, a indicates the radius of the borehole, r indicates the distance from the center of the borehole in a radial direction, Pₘ indicates the mud weight, α indicates the Biot's parameter, Pₚ indicates the pore water pressure, and θ indicates the angle between the x_{b} axis of the BCS and the horizontal axis of the CCS. Since the selected point is located on the borehole wall, the radial distance r from the center of the borehole is equal to the radius a of the borehole.

The stress components of the CCS which are calculated for the selected point are converted into those of the WCS by Equation 15 below.

$$\begin{matrix}{σ}_{ccs 2 wcs} = W \times {B}^{T} \times {C}^{T} \times {σ}_{ccs} \times C \times B \times {W}^{T} \\ = [ \begin{matrix}{σ}_{xx}^{w} & {τ}_{xy}^{w} & {τ}_{xz}^{w} \\ {τ}_{yx}^{w} & {σ}_{yy}^{w} & {τ}_{yz}^{w} \\ {τ}_{zx}^{w} & {τ}_{zy}^{w} & {σ}_{zz}^{w} \end{matrix} ]\end{matrix} \qquad [ Equation 15 ]$$

where B^{T} is the transpose matrix of B, and W^{T} the transpose matrix of W.

When the stress distribution of the WCS is calculated with respect to the selected point in this way, it is determined based on a result of the calculation whether or not the breakage caused by the weak plane occurs. Whether or not the breakage caused by the weak plane occurs is determined on the basis of Equation 16 below.

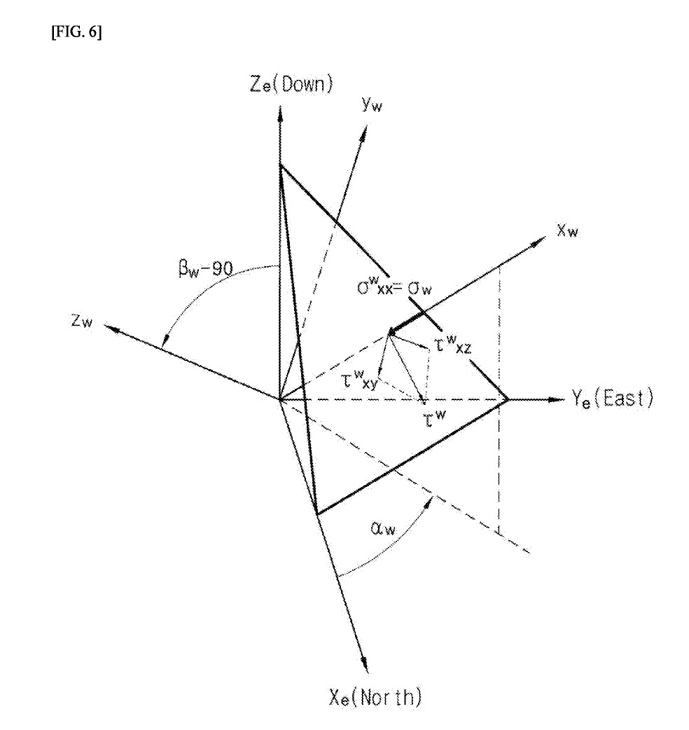

τ_{w}≧S_{w}+μ_{w}σ_{w} [Equation 16]

where τ_{w} is the resultant shear force applied to the weak plane, σ_{w} is the significant vertical stress applied to the weak plane, S_{W} is the cohesive force of the weak plane, and μ_{w} is the coefficient of friction of the weak plane. FIG. 6 is a view for illustrating vertical stress σ^{w}ₓₓ and two shear stresses τ^{w}_{xy} and τ^{w}_{xz} projected on the weak plane. The resultant shear force τ_{w} of Equation 16 corresponds to the resultant force of τ^{w}_{xy} and τ^{w}_{xz} shown in FIG. 6, and the significant vertical stress σ_{w} of Equation 16 corresponds to the vertical stress σₓₓ shown in FIG. 6.

As a result of the determination based on Equation 16, if it is determined that the breakage caused by the weak plane occurs despite the set mud weight, the mud weight is increased by a predetermined value. The resultant shear force τ_{w} and the significant vertical stress σ_{w}, both of which are applied to the weak plane, are calculated again on the basis of the increased mud weight, and then it is determined again on the basis of Equation 16 whether or not the breakage caused by the weak plane occurs. This process is repeated to find the maximum mud weight value at which the breakage caused by the weak plane at the selected point does not occur.

When the minimum mud weight value required to prevent the breakage caused by the weak plane at the selected point is calculated, the calculated mud weight value is stored. The aforementioned process is performed on a plurality of different points located on the borehole wall at the same depth as the selected point. Thereby, the maximum mud weight values for the respective points are calculated, and the calculated maximum mud weight values are stored.

To calculate the maximum mud weights required to prevent the breakage of the rock matrixes at the respective points, maximum significant principal stress σ′₁ and minimum significant principal stress σ′₃ are calculated. The maximum significant principal stress σ′₁ and minimum significant principal stress σ′₃ are equal to eigenvalues of a matrix σ_{ccs}. When the maximum significant principal stress σ′₁ and minimum significant principal stress σ′₃ are calculated, it is determined on the basis of Equation 17 whether or not the breakage of the rock matrix occurs. When Equation 17 is satisfied, it is determined that the breakage of the rock matrix occurs.

σ′₁=σ′₃+2(Sᵢ+μᵢσ′₃)(\sqrt{1+μᵢ²}+μᵢ) [Equation 17]

where Sᵢ is the cohesive force of the rock matrix, and μᵢ is the coefficient of friction of the rock matrix.

As a result of the determination based on Equation 17, when it is determined that the breakage of the rock matrix occurs despite the set mud weight, the mud weight is increased by a predetermined value. The maximum significant principal stress σ′₁ and minimum significant principal stress σ′₃, both of which are applied to the rock matrix, are calculated again on the basis of the increased mud weight, and then it is determined again on the basis of Equation 17 whether or not the breakage of the rock matrix occurs. This process is repeated to find the maximum mud weight value at which the breakage of the rock matrix at the selected point does not occur.

When the minimum mud weight value required to prevent the breakage of the rock matrix at the selected point is calculated, the calculated mud weight value is stored. The aforementioned process is performed on a plurality of different points located on the borehole wall at the same depth as the selected point. Thereby, the maximum mud weight values for the respective points are calculated, and the calculated maximum mud weight values are stored.

Subsequently, the greatest value of the minimum mud weight values required to prevent the breakage of the weak planes at the plurality of points located at a predetermined depth of the borehole is compared with the greatest value of the minimum mud weight values required to prevent the breakage of the rock matrixes at the plurality of points located at a predetermined depth of the borehole. The greater one of the two greatest values is set to a critical mud weight for preventing the breakage of the wall of the borehole having the set azimuth and dip angles, and is stored.

The aforementioned processes are performed on a borehole having azimuth and dip angles other than the set azimuth and dip angles. Thereby, the critical mud weight at which the wall of the borehole having different azimuth and dip angles is not broken is calculated, and is stored. The azimuth angle of the borehole may have a value between 0° and 360°, and the dip angle of the borehole may have a value between 0° and 90°.

To calculate the critical mud weights for all the azimuth and dip angles, the first azimuth angle is set to 0°, and then the dip angle is increased from 0° to 90° at a predetermined interval with respect to the set azimuth angle. Thereby, the critical mud weights for the increased dip angles can be calculated. Then, the dip angle is increased from 0° to 90° at a predetermined interval with respect to the azimuth angle increased by a predetermined angle, and thereby the critical mud weights for the increased dip angles can be calculated.

That is, the azimuth angle is sequentially increased from 0° to 360° by a predetermined angle, and the dip angle is increased from 0° to 90° by a predetermined angle with respect to each azimuth angle. Thereby, the critical mud weights for the respective azimuth and dip angles can be calculated.

As described above, when the borehole is formed using the critical mud weights acquired by the method of calculating mud weight in a borehole according to the embodiment of the present disclosure, the stability of the borehole can be improved.

Although exemplary embodiments have been described it will be readily understood by those skilled in the art that various modifications and changes can be made thereto without departing from the spirit and scope of the present disclosure defined by the appended claims.

What is claimed is:

1. A method of calculating mud weight in a borehole formed in a rock formation having a rock matrix and a weak plane, the method comprising:
calculating maximum mud weights required to prevent breakages occurring along the weak planes at a plurality of respective points located at a predetermined depth in a wall of the borehole having a predetermined azimuth angle and a predetermined dip angle based on information about the rock matrix, the weak plane, and the rock formation, and maximum mud weights required to prevent breakages of the rock matrixes at the plurality of respective points; and
comparing a greatest value of the maximum mud weights required to prevent breakages occurring along the weak planes with a greatest value of the maximum mud weights required to prevent breakages of the rock matrixes at the plurality of respective points, and setting a greater one of the greatest values to a critical mud weight at the predetermined depth of the borehole.

2. The method according to claim 1, wherein:
the information about the rock matrix comprises a cohesive force of the rock matrix and a coefficient of friction of the rock matrix;
the information about the weak plane comprises a cohesive force of the weak plane, a coefficient of friction of the weak plane, a dip angle of the weak plane, and a dip direction of the weak plane; and
the information about the rock formation comprises information about a state of in-situ stress defined by vertical stress, maximum horizontal stress, minimum horizontal stress, and an azimuth angle of the minimum horizontal stress, a Poisson's ratio of the rock formation, a Biot's parameter of the rock formation, and information about a pore water pressure in the rock formation.

3. The method according to claim 2, wherein the step of calculating maximum mud weights required to prevent breakages occurring along the weak planes comprises:
a first step of calculating in-situ stress distribution on the rock formation in a borehole coordinate system corresponding to the azimuth and dip angles of the borehole based on the information about the rock formation;
a second step of setting a predetermined mud weight supporting the wall of the borehole and calculating stress components applied to the wall at a point located at the depth of the wall of the borehole based on the mud weight and the in-situ stress distribution;
a third step of calculating the maximum mud weight required to prevent the breakage occurring along the weak plane at the point while changing the mud weight; and
a fourth step of sequentially repeating the second and third steps with respect to different points located at the depth of the wall of the borehole to calculate the maximum mud weights required to prevent the breakages occurring along the weak planes at the respective different points.

4. The method according to claim 3, wherein the second step comprises:
setting the predetermined mud weight; and
calculating stress components of the point in a cylindrical coordinate system based on both the in-situ stress distribution in the borehole coordinate system and the set mud weight.

5. The method according to claim 4, wherein the third step comprises:
projecting the stress components of the point in the cylindrical coordinate system on the weak plane, converting the stress components in the cylindrical coordinate system into stress components in a weak plane coordinate system, and calculating the stress components in the weak plane coordinate system;
determining whether or not the breakage caused by the weak plane occurs based on the stress components in the weak plane coordinate system and the information about the weak plane; and
when it is determined that the breakage caused by the weak plane occurs, increasing the set mud weight by a predetermined value to calculate the stress components in the weak plane coordinate system again based on the increased mud weight, and determining again whether or not the breakage caused by the weak plane occurs based on the re-calculated stress components in the weak plane coordinate system and the information about the weak plane.
